(19) United States
(12) Patent Application Publication
(10) Pub. No.: US 2014/0279644 A1
(43) Pub. Date: Sep. 18, 2014

(54) Systems and Methods for College Application and Offer Management

(71) Applicants: Gerry McCrory, West Chester, PA (US); Kevin McCloskey, West Chester, PA (US); Linda F Montemayor, Glenside, PA (US); Matthew Evan Sherman, Rockville, MD (US)

(72) Inventors: Gerry McCrory, West Chester, PA (US); Kevin McCloskey, West Chester, PA (US); Linda F Montemayor, Glenside, PA (US); Matthew Evan Sherman, Rockville, MD (US)

(21) Appl. No.: 14/215,015

(22) Filed: Mar. 16, 2014

Related U.S. Application Data
(60) Provisional application No. 61/789,318, filed on Mar. 15, 2013.

(51) Int. Cl. G06Q 50/20; G06Q 10/06

(52) U.S. Cl. CPC G06Q 50/2053; G06Q 10/06
USPC 705/327

(57) ABSTRACT

A method of matching applicants, such as high school students seeking college admissions, to institutions, such as colleges, includes the creation of applicant profiles for the various applicants and institutional profiles for the various institutions. The profiles can incorporate psychometric, psychographic, demographic, and/or biographical attributes. The attributes of institutions can be matched to those of applicants, thus providing colleges with improved data useful in admissions decisions, as well as providing students with improved data useful in making college application decisions. Social media functionality can also be included.

### CROSS-REFERENCE TO RELATED APPLICATIONS

This application claims the benefit of U.S. provisional application No. 61/789,318, filed 15 Mar. 2013, which is hereby incorporated by reference as though fully set forth herein.

### BACKGROUND

The instant disclosure relates to methods and systems for managing an application process, such as the college application process. In particular, the instant disclosure relates to methods and systems for matching the attributes of applicants (e.g., high school students) to the attributes of institutions to which they are applying (e.g., colleges and universities).

The process of applications to college has gone online, removing the need to create endless paper files. Yet, it suffers from multiple structural problems, from the perspective of applicants, colleges, and others (e.g., parents, guardians, and others who might pay for a student's education). These lead to inefficiencies, as well as to structural and societal problems that impact our ability as a nation to be effective in the global marketplace.

These shortcomings include the inefficiency of the college application process and the difficulty of matching colleges and applicants. The student application and college offer process is a limited information, asymmetric, competitive, multi-step matching process unlike any other.

An additional shortcoming is the lack of transparency regarding actual student costs, leaving parents, guardians, and other potential payers less able to guide student expectations and make informed decisions about which colleges students can/should apply to. This information deficit exists notwithstanding the requirements of the Higher Education Opportunity Act of 2008.

To understand the background of the current college application process, one can start by considering the entities affected by the application (that is, applicant to college) and offer (that is, college to applicant) process and the key issues facing the application and offer process.

While the primary participants in the application and offer process are the colleges (which fall within the term “institutions” as used herein) and the students (who fall within the term “applicants” as used herein), this is too narrow a view. For one thing, the application/offer process is between a subset of colleges and a subset of applicants. The definition of these two subsets and the management of these subsets is a very intricate process in its own right.

More broadly speaking, the participants in the application/offer process include: students; parents; providers of recommendations (who fall within the term “supporters” as used herein); high school counselors; high school officials; high school sports coaches; college recruiters; college admissions personnel; college financial aid officers; college administrators; college sports coaches; current college students; and alumni/alumnae. Ancillary participants include: collegiate associations; college boards; financial aid institutions; businesses; governments; marketing organizations; providers of coaching services; data-mining organizations; examination preparation services; college application platform providers (and their administrators).

Application to college requires the collection and management of hard data (e.g., standardized test scores, such as ACT and SAT scores, and grade point average), inclusion of qualitative academic information, qualitative and quantitative extra-curricular information, and qualitative and quantitative personal and economic information. Overwhelmed high school counselors have to keep track of hundreds of students, making the provision of one-on-one advice nearly impossible for many students.

Applying to college requires a disciplined process and is akin to competitive matchmaking. Unlike extant matchmaking systems (such as e-harmony, match.com, or the more traditional face-to-face meeting), students and colleges “date” multiple colleges and students. Unlike some dating, the matching is often performed remotely over months, even years, using a wide range of qualitative and quantitative criteria that can change dramatically for any number of reasons (a rush of applicants, a death in the family that changes the financial situation, etc.) and can change numerous times during the “dating” process.

Prospective applicants are inundated by emails and other communications from colleges, some desired or warranted, and others not. The comingling of communications at different stages of applications can be detrimental to focused discussions between applicants, counselors, and recruiters. Filtering electronic communications using tools such as white lists and black lists is not always effective, as too restrictive of a filter would result in important messages or opportunities being missed. Moreover, because applicants have a support structure to help them (parents, school counselors), applicants may want to share some communications and not share others.

Universities do not want to make offers to students who would decline them. This is true because university rankings, and therefore perceived university value, by national publications such as U.S. News and World Report is dependent in part on the rate of acceptance by students.

The dynamics of college financial aid are difficult to understand. This is true because of the complexity of rules and the dynamic nature of their applications (a school can target a good student with a specific scholarship). This means that the architecture of bidding-oriented online services is not applicable to the college application process. For example, the seller of an item on eBay cannot arbitrarily reduce the price of an item for one consumer and not another.

Some of the brightest low-income high school students do not to apply to the best colleges even though about 20 percent of the top-performing students come from the poorest quartile of the country. This is according to a 2012 study by Hoxby and Avery entitled “The Missing ‘One-Offs’: The Hidden Supply of High-Achieving, Low Income Students”, National Bureau of Economic Research, Working Paper No. 18586 issued in December 2012. These “low-income, high-achieving” students come from the poorest 25 percent of families, but their grades and SAT scores place them in the top 10 percent of all students. The majority of these smart, poor students do not apply to any selective college or university. Poor students with practically the same grades as their richer classmates are 75 percent less likely to apply to selective colleges, even though the most selective schools would actually cost them less, when financial aid is taken into consideration.

Social media networks (SMN) are online services, platforms, or sites that focus on building and reflecting social networks or social relations among people, who, for example, share interests and/or activities. A SMN typically includes a representation of each user (often a profile), his/her social links (or graph), and a variety of additional services. Most SMNs are web-based and provide means for users to interact over the Internet. Some SMNs provide dedicated mobile applications, and even Application Programming Interface (API) and Software Development Kits (SDK) for third parties to plug in or integrate with their offerings. Social networking sites allow users to share ideas, activities, events, and interests within their individual networks. Popular SMNs include Facebook™, MySpace™, Linkedln™, Twitter™, ASmallWorld™, Bebo™, Cyworld™, Diaspora™, Hi5™, Hyves™, Ning™, Orkut™, Plaxo™, Tagged™, XING™, and IRC™. Because of this focus and architecture around sharing, SMNs are ill-suited to provide private conversations or the identification and management of key events, performances, or accomplishments. SMNs are not architected to segregate who can comment on an event-by-event basis while restricting who can read these comments. They are ill-suited for the multi-step process of making applications to colleges and very ill-suited for the multi-step process of making offers to applicants.

Online Dating Services (ODS) rely on either 1) correlating key attributes of prospective mates such as race, age, stated likes, stated dislikes, and restrictions (for example, based on geography or previous children) or 2) analyzing individual profiles selected while browsing an online catalog. Feedback from live meetings (dates) can be included as part of the process. Unlike ODS, the applicants and colleges are openly dealing with multiple relationships simultaneously and attributes of colleges and applicants alike must be processed as a whole. Moreover, the matchmaking between colleges and students is asymmetric in economic terms, impact on reputation/future economic and societal position, and information knowledge. ODS, on the other hand, are inherently symmetric in nature.

Sports recruiting websites effectively only communicate the athlete's athletic achievements and tend to overlook the athlete as a student. In addition, there are restrictions enforced by the NCAA that include 1) prospective student-athletes must meet minimum academic standards and 2) colleges may not contact prospective student athletes until athletes are of certain age. Integrating sports and academic criteria is necessary to produce well-rounded, successful students and reduce the stigma often associated with students joining programs solely because of athletic accomplishments.

With an ever-growing number of entities selling collected personal information for commercial uses, students have the right to be concerned about sensitive information about their history and application process being misused. Thus, to be effective, a college application/matching platform must provide strong tools that limit/prevent intrusion, ensure authentication, and ensure the validity and non-repudiation of offers and acceptances. These types of issues have been addressed to some degree by online commercial services that provide marketplaces (such as Etsy™), retailing (such as Zappos™), excess capacity marketplaces (such as Zappos™), aggregators (such as Lastminute™), group buying (such as Groupon™ or Livingsocial™), auctions (such as eBay™), or reverse auctions (such as Priceline™). These services, however, have been architected in the context of one-on-one, one-on-many, or many-on-one frameworks, and are not suitable for use in the many-to-many environment of the college application process.

Reputation management is an important component of the application process as it is in digital marketplaces. The challenge is the many personas we have on the web. Establishing a system aside from Facebook, Twitter, Pheed and other interaction/sharing centric social systems allows for a focused relationship to be developed between applicants and colleges.

Waldrorf et al. teach in US Patent Application 2006/0697576 a method and system for identifying candidate colleges for prospective college students that uses a survey completed by a prospective college student, analyzing the survey data for relationships between one or more variables which correlate with actual college student satisfaction with their college experience, and identifying one or more candidate colleges for the prospective college student to consider by determining an association between the prospective college student's survey data and candidate colleges. This method suffers from the fact that it is not proactive and fails to guide the student. It is also incapable of differentiating between attributes that are mostly qualitative in nature.

Totten and Faraji teach in US Patent Application 2005/0159999 about ways to develop a relationship with students by presenting information to students about educational institutions by dynamically showing coupons to them. This is hardly compelling in current times as students and their support network have ready access to information on the Internet.

In the field of marketing, the term “brand loyalty” may be broadly understood as a consumer's commitment to repurchase or otherwise continue using a particular brand of product or service. Brand loyalty is typically demonstrated by repeated buying of a product or service or other positive behaviors such as word of mouth advocacy. Brand loyalty exists when customers have a high relative attitude toward the brand, which is then exhibited through repurchase behavior. Brand loyalty when applied to college is typically in the form of alumni/alumnae remaining involved with the university programs and/or purchases of items with the university logo/motto. There are no measurements of the loyalty or dedication that students will have to the application process. Colleges have limited or no measurement methods to validate whether a student is truly committed to attending their institution, other than making an offer and awaiting the response. This is, alas, at the end of the application process and often results in colleges making offers to students who do not accept the offer, or in colleges neglecting to make offers to qualified students who are very interested in attending their institution. There is a need to manage/gauge the true intent of applicants.

### BRIEF SUMMARY

Disclosed herein is a method of matching applicant attributes to institutional attribute criteria, including: (a) establishing a user interface via a server device; (b) receiving at the server device, through the user interface, a plurality of profile creation inputs from an applicant; (c) defining a plurality of applicant attributes for the applicant from the plurality of profile creation inputs, the plurality of applicant attributes including a psychometric attribute other than an analytical intelligence (IQ) attribute; (d) storing the plurality of applicant attributes as an applicant profile in an applicant database; (e) repeating steps (b), (c), and (d), thereby storing a plurality of applicant profiles in the applicant database; (f) receiving at the server device, through the user interface, a search query, wherein the search query includes an applicant attribute criterion other than an IQ attribute criterion; and (g) outputting from the server device, through the user interface, a subset of the plurality of applicant profiles, wherein the subset of the plurality of applicant profiles includes applicant profiles satisfying the applicant attribute criterion.

In certain aspects, the plurality of applicant attributes includes an applicant psychographic attribute, such as an interest attribute, an attitude attribute, or a behavior attribute.

It is contemplated that the psychometric attribute other than an analytical intelligence (IQ) attribute can be a creative intelligence (CQ) attribute, a practical intelligence (EQ) attribute, or a personality attribute.

According to an aspect disclosed herein, steps (b) and (c) discussed above can be accomplished by: presenting to the applicant, via the user interface, a plurality of assessment questions; receiving from the applicant, via the user interface, a plurality of responses to the plurality of assessment questions; and defining the plurality of applicant attributes for the applicant from the plurality of responses to the plurality of assessment questions.

A response of the plurality of responses to the plurality of assessment questions can optionally be published (for example, at the applicant's option), and feedback on the published response can be received from a party other than the applicant. This feedback can then be used to revise an applicant attribute of the plurality of applicant attributes. Third parties, such as athletic coaches, can also provide unsolicited input, which can be relevant to an attribute of the plurality of applicant attributes, and this unsolicited input can also be used to revise the attribute of the plurality of applicant attributes using the third party input.

In a further aspect, a graphical representation of the applicant profile, such as an avatar, can be established through the user interface. The avatar can reflect the applicant's attributes, the level of the applicant's participation, the extent to which the applicant has completed his or her profile, or a combination thereof.

It is also contemplated to store a plurality of institutional profiles for a plurality of institutions; and to output from the server device, through the user interface, a subset of the plurality of institutional profiles. The subset can include institutional profiles having institutional psychometric attribute criteria encompassing the plurality of applicant psychometric attributes for the applicant. That is, applicants can be provided with information regarding institutions that are seeking students that match their attributes, either on demand (e.g., in response to an institutional matching query) or automatically.

The plurality of profile creation inputs can also include a decision matrix weight corresponding to the applicant's relative interest in a particular institution.

Also disclosed herein is a method of matching applicants to institutions, including: (a) receiving at a server device a plurality of profile creation inputs for an institution; (b) defining a plurality of institutional attributes for the institution from the plurality of profile creation inputs for the institution; (c) storing the plurality of institutional attributes as an institutional profile in an institutional database; (d) repeating steps (a), (b), and (c), thereby storing a plurality of institutional profiles in the institutional database; (e) receiving at the server device a plurality of profile creation inputs for an applicant; (f) defining a plurality of applicant attributes for the applicant from the plurality of profile creation inputs for the applicant; (g) storing the plurality of applicant attributes as an applicant profile in an applicant database; (h) repeating steps (e), (f), and (g), thereby storing a plurality of applicant profiles in the applicant database; and (i) outputting from the server device a match between an applicant profile in the applicant database and an institutional profile in the institutional database.

In certain embodiments, the plurality of institutional attributes includes an institutional psychographic attribute; and the plurality of applicant attributes includes an applicant psychometric attribute other than an analytical intelligence (IQ) attribute.

The server device can also receive a search query that includes at least one of an applicant psychometric attribute criterion other than an IQ attribute criterion and an institutional psychographic attribute criterion. In some aspects, the match is output from the server device in response to the search query.

In another aspect, a system for matching applicants to institutions, includes: an institutional database comprising a plurality of institutional profiles; an applicant database comprising a plurality of applicant profiles; an institutional profiling processor that receives a plurality of profile creation inputs for an institution, defines therefrom a plurality of institutional attributes, and stores the plurality of institutional attributes as an institutional profile in the institutional database; an applicant profiling processor that receives a plurality of profile creation inputs for an applicant, defines therefrom a plurality of applicant attributes, and stores the plurality of applicant attributes as an applicant profile in the applicant database; and a matching processor that outputs a match between an applicant profile in the applicant database and an institutional profile in the institutional database. For example, the matching processor can output a plurality of matches between a selected applicant profile in the applicant database and a plurality of institutional profiles in the institutional database and/or a plurality of matches between a selected institutional profile in the institutional database and a plurality of applicant profiles in the applicant database.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts a representative computing environment.

FIG. 2 is a flowchart of representative steps that can be carried out to match applicant psychometric attributes to institutional psychometric attribute criteria according to an embodiment of the teachings herein.

FIG. 3 illustrates a user interface according to an embodiment of the teachings herein.

FIGS. 4 and 5a through 5f illustrate various psychometric attribute assessment questions according to embodiments disclosed herein.

FIGS. 6 and 7 depict representative user interfaces for displaying certain applicant psychometric criteria as described herein.

FIG. 8 is a representative screenshot of an institution's establishment of applicant psychometric attribute criteria.

FIGS. 9a and 9b are, respectively, representative screenshots of basic and detailed search results responsive to an institution's search using applicant psychometric attribute criteria.

FIG. 10 depicts one suitable screen for presenting an applicant with matching institutions.

FIG. 11 depicts one suitable screen for presenting an applicant with a gap report that shows the applicant “near match” institutions and the reasons why such institutions are not actual matches.

FIG. 12 is a representative user interface that allows an applicant to numerically define his or her interest in particular institutions.

FIG. 13 illustrates a representative user interface for an institution admissions representative to manage admissions offers.

### DETAILED DESCRIPTION

The present disclosure provides methods and systems for matching applicants and institutions. For purposes of illustration, several exemplary embodiments will be described in detail herein the context of a college application process, where the “institutions” are colleges, universities, and the like and the “applicants” are high school students seeking admission thereto. It should be understood, however, that the methods and systems described herein can be utilized in other contexts to good advantage. For example, the methods and systems herein can be practiced by “applicants” for jobs or internships, where the “institutions” are employers (e.g., businesses, government agencies).

FIG. 1 depicts a representative computing environment 10 in which the teachings herein can be practiced. Environment 10 generally includes a plurality of client computing devices 12, each belonging to and/or used by a corresponding user 14. Although three client computing devices 12 and corresponding users 14 are shown in FIG. 1, this is only for the sake of illustration, and environment 10 can include any number of computing devices 12 and corresponding users 14 without departing from the instant teachings.

Client computing devices 12 can be any computing device including, without limitation, general purpose computers, special purpose computers, distributed computers, desktop computers, laptop computers, tablet computers, smartphones, personal digital assistants, e-readers, and the like. In general, client computing devices 12 include a processor, memory (e.g., random access memory, or “RAM”), storage (e.g., a hard drive or solid state drive), and a display. As used herein, the term “processor” refers to not only a single central processing unit (“CPU”), but also to a plurality of CPUs, commonly referred to as a parallel processing environment. Client computing devices 12 can include additional devices, such as various input devices (e.g., keyboards, trackpads, touchscreens) and output devices (e.g., speakers, printers).

Users 14 can include any of the participants in the college offer/acceptance process. As discussed above, this can include students, parents, college administrators, guidance counselors, and the like. Users can be broadly classified into three groups: applicant (including students and their support group members, such as their parents, friends, and the like), high school professionals (including high school counselors, high school athletic coaches, and the like), and college professionals (including college admissions officers, college financial aid officers, and the like).

Client computing devices 12 are coupled to a network 16, such as the Internet. Thus, client computing devices 12 and/or users 14 can communicate with each other over network 16. The ordinarily skilled artisan will be familiar with numerous ways to connect client computing devices 12 to network 16, including via wire (e.g., Ethernet) or via a wireless connection (e.g., 802.11, Bluetooth). Amongst other capabilities, client computing devices 12 can include a browser, such as Microsoft's Internet Explorer browser, Apple's Safari browser, Mozilla's Firefox browser, Google's Chrome browser, or the like, as well as native client applications, that can be used to access network 16 (e.g., the Internet).

A server device 18 is also coupled to network 16, thus allowing client computing devices 12 to communicate with server device 18. Similar to client computing devices 12, server device 18 can include a processor, memory, storage, and a display, as well as additional devices. Moreover, although server device 18 is depicted as a single machine, it is contemplated that server device 18 can be a distributed computing environment including multiple physical and/or virtual devices including multiple CPUs, multiple cores, and/or multiple threads.

According to embodiments disclosed herein, applicant psychometric profiles and institutional psychometric profiles are matched as part of college admissions process. FIG. 2 is a flowchart 20 of representative steps that can be carried out to match applicant psychometric attributes (e.g., applicant psychometric profiles) to institutional psychometric attribute criteria (e.g., institutional search criteria). In some embodiments, flowchart 20 may represent several exemplary steps that can be carried out by server device 18 (e.g., by one or more processors). It should be understood that the representative steps described below can be either hardware- or software-implemented.

In block 22, a user interface is established. This user interface can be established, for example, by server device 18 executing computer-readable program instructions that are stored in its memory and/or storage. The interface can be established on the display of a client computing device 12, such as in response to a request from client computing device 12 that takes the form of user 14 using the browser of client computing device 12 to visit a particular uniform resource locator (“URL”) for server device 18, and, more particularly, for the functions of server device 18 as described herein. FIG. 3 depicts a user interface 300 as implemented in an exemplary method and system according to the teachings herein.

In block 24, server device 18 receives a plurality of profile creation inputs from an applicant through the user interface established in block 22. These profile inputs can include psychometric inputs, psychographic inputs, and demographic inputs.

As used herein, “psychometrics” refers to the science of assessing and measuring mental capacities and processes. “Psychometric attributes” are those personal characteristics relating to the same, including, without limitation, creative intelligence (“CQ”) attributes, practical intelligence (“EQ”) attributes, analytical intelligence (“IQ”) attributes, and personality attributes.

“Psychographics” is the science of assessing and measuring personality formation, interests, attitudes, opinions, and behaviors. “Psychographic attributes” are those personal characteristics relating to the same, including, without limitation, interest attributes, environmental attributes, and behavioral attributes.

“Demographics” are the quantifiable statistics of a given population, and subsets within that population, that characterize the population at a specific point in time. Common demographic attributes include age, gender, ethnicity, location, income, and environment.

In block 26, server device 18 uses the profile creation inputs received in block 24 to create and store an applicant profile in an applicant database. The applicant profile can include various applicant attributes, which can be selected from the psychometric attributes, psychographic attributes, and demographic attributes discussed above.

Thus, as part of the creation of the applicant profile, server device 18 can use the profile creation inputs received in block 24 to define one or more applicant psychometric attributes, one or more applicant psychographic attributes, and one or more applicant demographic attributes. Each of these applicant attributes can be assessed and measured in various ways.

For example, in certain aspects, server device 18 causes a plurality of assessment questions 400 to be presented to the applicant through the user interface, for example as depicted in FIG. 4. Similarly, server device 18 receives the applicant's responses to the assessment questions. These responses, in turn, can be used to define, redefine, and/or refine the applicant's attributes.

CQ attributes include, without limitation, performance creativity, visual creativity, verbal creativity, interpersonal creativity, and scientific discovery. These attributes can be assessed and quantified, for example, using divergence tests as described in “Outliers: The Story of Success” by Malcolm Gladwell, Torrance Tests of Creative Thinking, and Creativity Achievement Questionnaires (“CAQ”). An exemplary CAQ assessment question, developed to assess verbal creativity, is shown in FIG. 5a.

IQ attributes include, without limitation, vocabulary, comprehension, mathematics, and problem-solving skills. Familiar quantifications of these attributes are grade point averages (“GPA”) and standardized test scores (e.g., SAT, ACT, AP), and the user interface can include the ability of the applicant to input these statistics (see FIG. 6). IQ attributes can also be assessed and quantified through traditional IQ tests, such as spatial reasoning tests, which include assessment questions similar to those shown in FIGS. 4 and 5b.

EQ attributes include, without limitation, self-awareness, self-management, social awareness, and relationship management. These attributes can be assessed and quantified, for example, using the Emotional and Social Competency Inventory (“ESCI”), as developed by Daniel Goleman and Richard Boyatzis. An exemplary EQ assessment question, developed to assess social awareness, is shown in FIG. 5c.

Personality attributes include, without limitation, conscientiousness, openness, emotional stability, agreeableness, and extroversion. These attributes can be assessed and quantified, for example, using the Revised NEO Personality Inventory (“NEO PI-R”). An exemplary personality attribute assessment question, designed to measure openness, is shown in FIG. 5d.

Interest attributes can be described, for example, by Holland Code Tests, which is a theory of careers and vocational choice based upon personality types as measured across attributes defined as realistic, investigative, artistic, social, enterprising, and conventional. A sample assessment question, designed to gauge conventional interests, is shown in FIG. 5e. Interest attributes can also be directly input by the applicant as discussed below.

Environmental attributes include, for example, family stability, socio-economic stability, and scholastic stability. These attributes can be quantified, for example, by gathering and assessing biographic and demographic data. A sample assessment question, designed to gauge family stability, is shown in FIG. 5f.

In addition to being quantified, environmental attributes can be used to “normalize” other applicant attributes, and in particular IQ attributes. Thus, for example, suppose one applicant with a 3.1 GPA and 1960 SAT is from a poor neighborhood with one working parent and three younger siblings who has changed schools twice in the past five years, whereas another applicant has a 3.8 GPA and 2240 SAT is from a good school and a stable family. The environmental attributes of the former student can be used to adjust his or her IQ attributes so that they appear (properly) more on par with those of the latter student than one would recognize from simply reviewing the raw numbers.

Interest and environmental attributes can also be reflected in narrative form, such as shown in FIG. 7. The applicant's narrative input can, however, be parsed for certain terms (e.g., particular interests that closely correlate to specific interest attributes, or terms that reflect environmental stability or the lack thereof), and the results of this parsing can be used by server device 18 in defining the applicant's interest attributes and/or environmental attributes.

Assessment and definition of the applicant's attributes can be further refined by crowdsourcing. Thus, in certain embodiments, the applicant can choose to publish his or her response to a particular assessment question, typically on an anonymous basis, and then receive feedback on that response from others. The feedback can then be accounted for when assessing and defining (or re-defining) the applicant's attributes.

Alternatively or additionally, the applicant can voluntarily publish content, typically anonymously, and then receive feedback on that response from others. The feedback can be accounted for when assessing and defining (or re-defining) the applicant's psychometric attributes.

In still other embodiments, other users, such as an athletic coach, can provide unsolicited third party input, which can be accounted for when assessing and defining (or re-defining) the applicant's attributes.

Assessment and definition of applicant attributes through crowdsourcing works particularly well for CQ attributes, which can be difficult to measure using traditional methods. It can, however, be applied to any of the applicant attributes discussed herein.

The steps in blocks 24 and 26 can be repeated a plurality of times, by a plurality of applicants. As such, a plurality of applicant profiles can be stored in the applicant database.

The applicant's profile can also be represented graphically, such as by an avatar that reflects the plurality of applicant attributes, the applicant's participation level (e.g., a gamification element that rewards the applicant, for example, for soliciting and/or providing feedback, with the ability, for example, to alter the appearance of his or her avatar), the state of completion of the applicant's profile (e.g., does it contain merely basic biographical data, or does it contain a more robust dataset including psychometric, psychographic, and/or demographic attributes), or a combination thereof. Thus, for example, the applicant's avatar can start in a nascent state, such as an egg. As the applicant completes aspects of his or her profile, the egg can crack. Over time, and with additional information, the avatar can develop characteristics that reflect the applicant's profile.

Likewise, an analogous set of steps can be followed by representatives from a plurality of institutions in order to create a plurality of institutional profiles stored in an institutional database. That is, for each institution, server device 18 can receive a plurality of profile creation inputs for an institution, define a plurality of institution attributes for the institution therefrom, and store the plurality of institutional attributes as an institutional profile.

Institutional profiles can also be developed from crowdsourced information. For example, current students and/or alumni/alumnae of the institution can be asked to complete various questionnaires or assessments regarding the institution, and their responses can be used to assess and define (or re-define) institutional attributes, and thus the institution's profile.

Of course, although there may be overlap between applicant attributes and institutional attributes, they may not apply in the same ways. For example, whereas an applicant may have an IQ attribute defined by his or her own GPA or SAT score, an institution's IQ attribute may be defined by the average GPA or average SAT of its student body. As another example, whereas environmental attributes for an applicant might reflect that applicant's home life, environmental attributes for an institution can include student body size, majors offered, athletics, and the like. As a further example, whereas applicant psychographic attributes will be individualized to a particular student, institutional psychographic attributes can describe the student body as a whole (e.g., competitive, laid-back, partying, studious, and the like). From these examples, the ordinarily skilled artisan will understand how to translate and map the applicant attributes described above into the institutional context.

According to aspects disclosed herein, applicants can search the institutional database and/or institutions can search the applicant database in order to find suitable matches. Extant systems permit limited searching of this nature. For example, high school students can search for colleges based on demographic data. Similarly, colleges can search for students based on limited demographic attributes (e.g., age, gender, ethnicity, location) and limited psychometric attributes (e.g., IQ, as measured by GPA and standardized test scores).

The methods and systems disclosed herein advantageously broaden the universe of attributes that are available for inclusion in an applicant's or institution's search query. Thus, for example, in block 28, server device 18 can receive a search query from an institution. The search query specifies applicant attributes that the institution desires, referred to herein as an “applicant attribute criterion.” In some aspects, the applicant attribute criterion will include at least one applicant psychometric attribute criterion other than an IQ attribute. Of course, it can also include one or more applicant psychographic attribute criteria and/or one or more applicant demographic criteria.

FIG. 8 depicts a set of applicant attribute criteria 800. As can be seen to good advantage in FIG. 8, institutions are able to set criteria across the full spectrum of psychometric, psychographic, and demographic attributes, rather than simply seeking only those applicants, for example, with the highest GPA and SAT scores. Indeed, it is contemplated that institutions can prescribe multiple sets of applicant attribute criteria in order to create a well-rounded class of academic achievers with various backgrounds, experiences, personalities, interests, and other attributes.

In block 30, server device 18 outputs search results responsive to the search query received in block 28. These search results include those applicant profiles that satisfy the applicant attribute criteria set by the institution. It can also include applicant profiles that nearly satisfy the applicant attribute criteria (e.g., “near matches” to the search query). The user (e.g., the applicant or institution submitting the search query) can define what constitutes a “near match.” For example, an institution can specify a particular percentile for CQ (e.g., 78%, as shown in FIG. 8), such that “matches” are students in the 78^{th} or higher percentile for CQ. The institution can further specify that “near matches” are students in the 75^{th} or higher percentile.

The search results can be presented in a number of different ways. For example, as shown in FIG. 8, a bar graph 802 can show (1) the total number of applicant profiles in the applicant database; (2) the number of applicants who have expressed interest in a particular institution; (3) the number of applicants who match the institution's applicant attribute criteria; and (4) the number of “perfect matches”—that is, the intersection between categories (2) and (3), above.

As another example, FIG. 9a shows search results presented as a basic list view. A more detailed list view is shown in FIG. 9b. The institution can also retrieve individual applicant profiles, for example by clicking in either the basic list view of FIG. 9a or the detailed list view of FIG. 9b.

It is also contemplated that applicants can use a similar process to search the institutional database. For example, in some embodiments, an applicant can submit a matching query to server device 18, and server device 18 can return search results reflecting those institutions that have institutional attributes encompassing the applicant's attributes. That is, server 18 can provide a list to the applicant of those institutions interested in students having the applicant's profile. These matching results can also simply be “pushed” to the applicant without requiring the applicant to submit a specific query. For example, as depicted in FIG. 10, the applicant's “best matches” can automatically be shown on the applicant's profile page.

FIG. 11 shows a “gap report” for an applicant. The gap report shows near matches between applicants and institutions—for example, institutions where the applicant's attributes fall just outside of the attribute criteria. This information allows the applicant to strive to close the gaps, thereby matching to the institution. Alternatively, it allows the applicant to orient himself or herself to what institutions are within reach (“safety schools”), which are reach schools, and which are likely out of reach entirely.

In addition, applicants can use the system disclosed herein to research institutions (e.g., information gathering). For example, search capabilities can be provided that allow applicants to explore institutional psychometric attributes, institutional psychographic attributes, and institutional demographic attributes, and to construct queries including criteria regarding any of the foregoing. Indeed, it is contemplated that the applicant can have a decision matrix, shown in FIG. 12, that allows the applicant to set weights reflecting how interested the applicant is in a particular institution. The applicant's decision matrix weights can also be shown to the institutions, allowing the institutions to more effectively recruit (e.g., they no longer need to blanket mail or mass email, and can instead more precisely target interested applicants, or “sweeten the pot” to push a particularly desirable applicant towards accepting an admissions offer). Of course, applicants can be offered the opportunity to opt-in (or opt-out) of such marketing and engagement.

In some embodiments, social media functionality is included. Thus, for example, an applicant can invite “supporters,” such as references or recommenders, or connect with “buddies,” such as current students at particular institutions. Similarly, the social media functionality can include private messaging, picture and video albums, and other features that will be familiar to those of ordinary skill in the art.

Institutions can also use the systems and methods disclosed herein to make admissions offers to applicants, to manage outstanding offers, and to target potential students for follow up with greater specificity than in extant systems and methods (that is, as a more effective recruitment tool). One suitable user interface for institutional admissions management is shown in FIG. 13.

Likewise, high school professionals can utilize the systems and methods disclosed herein to monitor the progress of their students in applying to institutions of higher education. Thus, for example, a high school counselor can view profile completion status, applicant profiles, applicant-to-institution matches, gap reports, and the like. This information can then be leveraged in counseling the applicants.

Parents can also use the systems and methods disclosed herein to track the progress of their children. It is also contemplated that the systems and methods disclosed herein can provide improved financial calculators, which take into consideration information obtained from Free Application for Federal Student Aid (“FAFSA”) and College Scholarship Service (“CSS”) profiles, while also providing parents a longer term perspective to more accurately estimate the cost of sending their children to particular institutions over a period of several years. For example, the systems and methods disclosed herein can include a financial planning tool that allows parents to develop projections, budgets, and the like for the costs of sending their children to college, not just over a single-year period, but also over the entire period during which all of their children will be in college.

Likewise, by making financial and economic information available to the institutions, either on an individualized basis or on the basis of the entire applicant pool, institutions can more effectively recruit (e.g., by offering scholarships to particular applicants) and maximize their revenue stream (e.g., by sculpting their class to include applicants from various financial and/or economic strata).

Although several embodiments of this invention have been described above with a certain degree of particularity, those skilled in the art could make numerous alterations to the disclosed embodiments without departing from the spirit or scope of this invention.

For example, although the profile creation inputs described above relate to the assessment and definition of applicant psychometric, psychographic, and demographic attributes, additional profile creation inputs, such as biographical attributes (e.g., name, address, email address, phone number, identification of family members, identification of friends), media elements (e.g., photographs, videos), and the like, are also contemplated.

As another example, the applicant can be provided the option to complete additional assessment questions at any time, and not just at initial sign-up. These additional assessment questions can have an immediate impact on the applicant's attributes. These additional “on demand” assessment questions can be used, for example, to address any gaps in the applicant's gap report, and improve, for example, their CQ attribute to a point that it better matches a college of particular interest.

As yet another example, the systems and methods disclosed herein are not limited to use by high school students. Indeed, it is expressly contemplated that middle school, or even younger, students can also create profiles. Similarly, college students can use the systems and methods disclosed herein for purposes of transferring between colleges, for applying to graduate school, for applying to jobs, and the like.

As still a further example, it is contemplated that the functionality of the systems disclosed herein can be expanded to the submission of college applications. This can include not only the information that would appear on a traditional paper application, but also the submission of recorded applicant interviews, as well as a portfolio of the applicant's work (e.g., writings, works of art, theatrical performances, and the like).

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of matching applicant attributes to institutional attribute criteria, comprising:
(a) establishing a user interface via a server device;
(b) receiving at the server device, through the user interface, a plurality of profile creation inputs from an applicant;
(c) defining a plurality of applicant attributes for the applicant from the plurality of profile creation inputs, the plurality of applicant attributes including a psychometric attribute other than an analytical intelligence (IQ) attribute;
(d) storing the plurality of applicant attributes as an applicant profile in an applicant database;
(e) repeating steps (b), (c), and (d), thereby storing a plurality of applicant profiles in the applicant database;
(f) receiving at the server device, through the user interface, a search query, wherein the search query comprises an applicant attribute criterion other than an IQ attribute criterion; and
(g) outputting from the server device, through the user interface, a subset of the plurality of applicant profiles, wherein the subset of the plurality of applicant profiles includes applicant profiles satisfying the applicant attribute criterion.

2. The method according to claim 1, wherein the plurality of applicant attributes further comprises an applicant psychographic attribute.

3. The method according to claim 2, wherein the applicant psychographic attribute comprises an interest attribute, an attitude attribute, or a behavior attribute.

4. The method according to claim 1, wherein the psychometric attribute other than an analytical intelligence (IQ) attribute comprises a creative intelligence (CQ) attribute, a practical intelligence (EQ) attribute, or a personality attribute.

5. The method according to claim 1, wherein steps (b) and (c) further comprise:
presenting to the applicant, via the user interface, a plurality of assessment questions;
receiving from the applicant, via the user interface, a plurality of responses to the plurality of assessment questions; and
defining the plurality of applicant attributes for the applicant from the plurality of responses to the plurality of assessment questions.

6. The method according to claim 5, further comprising:
publishing a response of the plurality of responses to the plurality of assessment questions; and
receiving feedback on the published response from a party other than the applicant.

7. The method according to claim 6, further comprising revising an applicant attribute of the plurality of applicant attributes using the feedback.

8. The method according to claim 1, further comprising receiving third party input regarding the applicant from a party other than the applicant, wherein the third party input is relevant to an attribute of the plurality of applicant attributes.

9. The method according to claim 8, further comprising revising the attribute of the plurality of applicant attributes using the third party input.

10. The method according to claim 8, wherein the party other than the applicant comprises an athletic coach for the applicant.

11. The method according to claim 1, further comprising establishing, through the user interface, a graphical representation of the applicant profile.

12. The method according to claim 11, wherein the graphical representation of the applicant profile comprises an avatar reflective of at least one of the plurality of applicant attributes, the applicant's level of participation, and an amount of data contained within the applicant profile.

13. The method according to claim 1, further comprising:
storing a plurality of institutional profiles for a plurality of institutions; and
outputting from the server device, through the user interface, a subset of the plurality of institutional profiles, wherein the subset of the plurality of institutional profiles includes institutional profiles having institutional psychometric attribute criteria encompassing the plurality of applicant psychometric attributes for the applicant.

14. The method according to claim 13, further comprising receiving from the applicant through the user interface, an institutional matching query, wherein the subset of the plurality of institutional profiles is output in response to the institutional matching query.

15. The method according to claim 1, wherein the plurality of profile creation inputs comprises a decision matrix weight corresponding to the applicant's relative interest in a particular institution.

16. A method of matching applicants to institutions, comprising:
(a) receiving at a server device a plurality of profile creation inputs for an institution;
(b) defining a plurality of institutional attributes for the institution from the plurality of profile creation inputs for the institution;
(c) storing the plurality of institutional attributes as an institutional profile in an institutional database;
(d) repeating steps (a), (b), and (c), thereby storing a plurality of institutional profiles in the institutional database;
(e) receiving at the server device a plurality of profile creation inputs for an applicant;
(f) defining a plurality of applicant attributes for the applicant from the plurality of profile creation inputs for the applicant;
(g) storing the plurality of applicant attributes as an applicant profile in an applicant database;
(h) repeating steps (e), (f), and (g), thereby storing a plurality of applicant profiles in the applicant database; and
(i) outputting from the server device a match between an applicant profile in the applicant database and an institutional profile in the institutional database.

17. The method according to claim 16, wherein
the plurality of institutional attributes comprises an institutional psychographic attribute; and
the plurality of applicant attributes comprises an applicant psychometric attribute other than an analytical intelligence (IQ) attribute.

18. The method according to claim 16, further comprising receiving a search query at the server device, wherein the search query comprises at least one of an applicant psychometric attribute criterion other than an IQ attribute criterion and an institutional psychographic attribute criterion.

19. The method according to claim 18, wherein the match is output from the server device in response to the search query.

20. A system for matching applicants to institutions, comprising:
an institutional database comprising a plurality of institutional profiles;
an applicant database comprising a plurality of applicant profiles;
an institutional profiling processor that receives a plurality of profile creation inputs for an institution, defines therefrom a plurality of institutional attributes, and stores the plurality of institutional attributes as an institutional profile in the institutional database;
an applicant profiling processor that receives a plurality of profile creation inputs for an applicant, defines therefrom a plurality of applicant attributes, and stores the plurality of applicant attributes as an applicant profile in the applicant database; and
a matching processor that outputs a match between an applicant profile in the applicant database and an institutional profile in the institutional database.

21. The system according to claim 20, wherein the matching processor outputs a plurality of matches between a selected applicant profile in the applicant database and a plurality of institutional profiles in the institutional database.

22. The system according to claim 20, wherein the matching processor outputs a plurality of matches between a selected institutional profile in the institutional database and a plurality of applicant profiles in the applicant database.
